(19) United States
(12) Patent Application Publication
(10) Pub. No.: US 2011/0303469 A1
(43) Pub. Date: Dec. 15, 2011

(54) VEHICLE SEAT LOAD SENSOR

(76) Inventors: Noboru Saito, Saitama (JP); Shunji Kawashima, Saitama (JP)

(21) Appl. No.: 13/139,013

(22) PCT Filed: Dec. 4, 2009
(86) PCT No.: PCT/JP2009/070381

§ 371 Date: Jun. 10, 2011

(30) Foreign Application Priority Data
Dec. 11, 2008 (JP) 2008-315782

(51) Int. Cl. G01G 19/08

(52) U.S. Cl. 177/136

(57) ABSTRACT

A vehicle seat load sensor which is attached under a vehicle seat, and is configured to detect a load acting on the vehicle seat includes a seat support configured to support a vehicle seat, and a flexible body configured to receive the load from the seat support, the seat support including a seat support surface configured to support the vehicle seat and a projection which is formed on the seat support surface and is configured to have contact with the vehicle seat.

### TECHNICAL FIELD

The present invention relates to a vehicle seat load sensor which is mounted under a slidable vehicle seat, so as to detect a load acting on the vehicle seat.

### BACKGROUND ART

A vehicle seat load sensor is known including a seat support which supports a slidable vehicle seat, a load transmitter which transmits a load from the seat support, a flexible body which receives the load transmitted from the load transmitter and a holder which holds the flexible body (for example, refer to Patent Document 1).

### PRIOR ART DOCUMENT

### Patent Document

Patent Document 1: Japanese Patent Application Publication No. 2008-134232

This vehicle seat load sensor is disposed between a seat rail which guides the vehicle seat and the vehicle seat, and can be movable along the seat rail together with the vehicle seat. If a load acts on the vehicle seat by seating of a passenger or the like, strain is generated in the flexible body between the load transmitter and the holder, so that the vehicle seat load sensor detects the load based on the magnitude of the strain.

### DISCLOSURE OF THE INVENTION

### Problem to be Solved by the Invention

Since the above vehicle seat load sensor is movable together with the vehicle seat, the vehicle seat load sensor may relatively incline to the vehicle seat by the attachment error of the seat rail, the size error of the component or the like. By this inclination, the load to the vehicle seat load sensor is biased, so that unnecessarily strain may be generated in the flexible body. Accordingly, there has been a problem in that detection errors are caused by this unnecessary strain.

It is, therefore, an object of the present invention to provide a vehicle seat load sensor which prevents the generation of unnecessary strain of a flexible body even if the vehicle seat load sensor relatively inclines to a vehicle seat, so as to prevent a detection error.

### Means for Solving the Problem

In order to achieve the above object, a vehicle seat load sensor according to the present invention, which is attached under a vehicle seat, and is configured to detect a load acting on the vehicle seat includes a seat support configured to support a vehicle seat, and a flexible body configured to receive the load from the seat support, the seat support including a seat support surface configured to support the vehicle seat and a projection which is formed on the seat support surface and is configured to have contact with the vehicle seat.

### BRIEF DESCRIPTION OF THE DRAWINGS

FIG. 1 is a perspective view illustrating a vehicle seat to which vehicle seat load sensors according to an embodiment of the present invention are applied.

FIG. 2 is an exploded perspective view illustrating the vehicle seat load sensor according to the embodiment of the present invention.

FIG. 3 is a longitudinal sectional view illustrating the vehicle seat load sensor according to the embodiment of the present invention.

FIG. 4 is a perspective view illustrating a shaft portion in the vehicle seat load sensor according to the embodiment of the present invention.

FIG. 5A is a graph illustrating the variation of the output values of the load sensors when a cushioning member is provided if a distance between seat rails is long on the back side.

FIG. 5B is a graph illustrating the variation of the output values of the load sensors when the cushioning member is provided if a distance between the seat rails is long on the front side.

FIG. 6A is a graph illustrating the variation of the output values of the load sensors when a contact projection having a width of 5 mm in the lateral direction is provided on a seat support surface if a distance between the seat rails is long on the back side.

FIG. 6B is a graph illustrating the variation of the output values of the load sensors when the contact projection having a width of 5 mm in the lateral direction is provided on the seat support surface if a distance between the seat rails is long on the front side.

FIG. 7A is a graph illustrating the variation of the output values of the load sensors when the contact projection having a width of 10 mm in the lateral direction is provided on the seat support surface if a distance between the seat rails is long on the back side.

FIG. 7B is a graph illustrating the variation of the output values of the load sensors when the contact projection having a width of 10 mm in the lateral direction is provided in the seat support surface if a distance between the seat rails is large on the front side.

FIG. 8 is a perspective view illustrating a modified example of the shaft.

### MODE FOR CARRYING OUT THE INVENTION

Hereinafter, a vehicle seat load sensor according to an embodiment of the present invention will be described with reference to the drawings.

### Embodiment

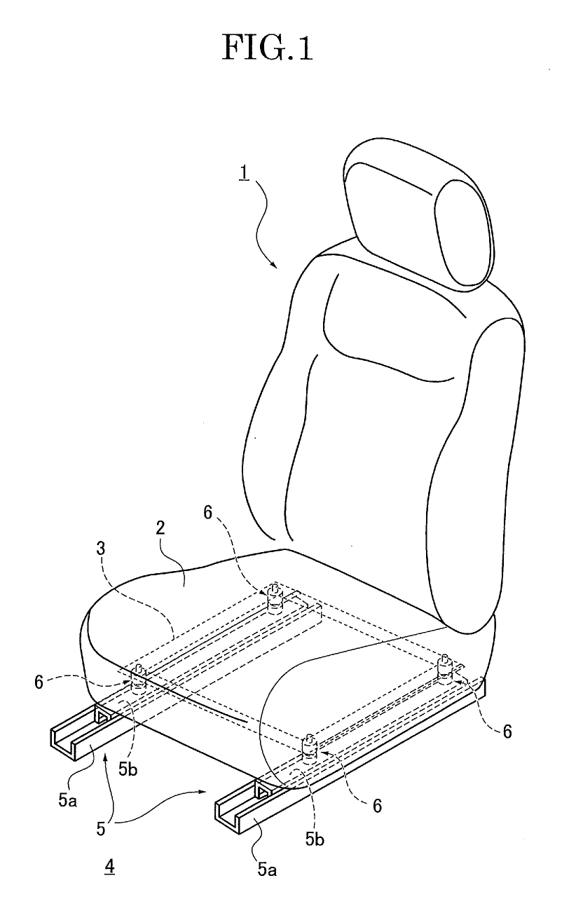

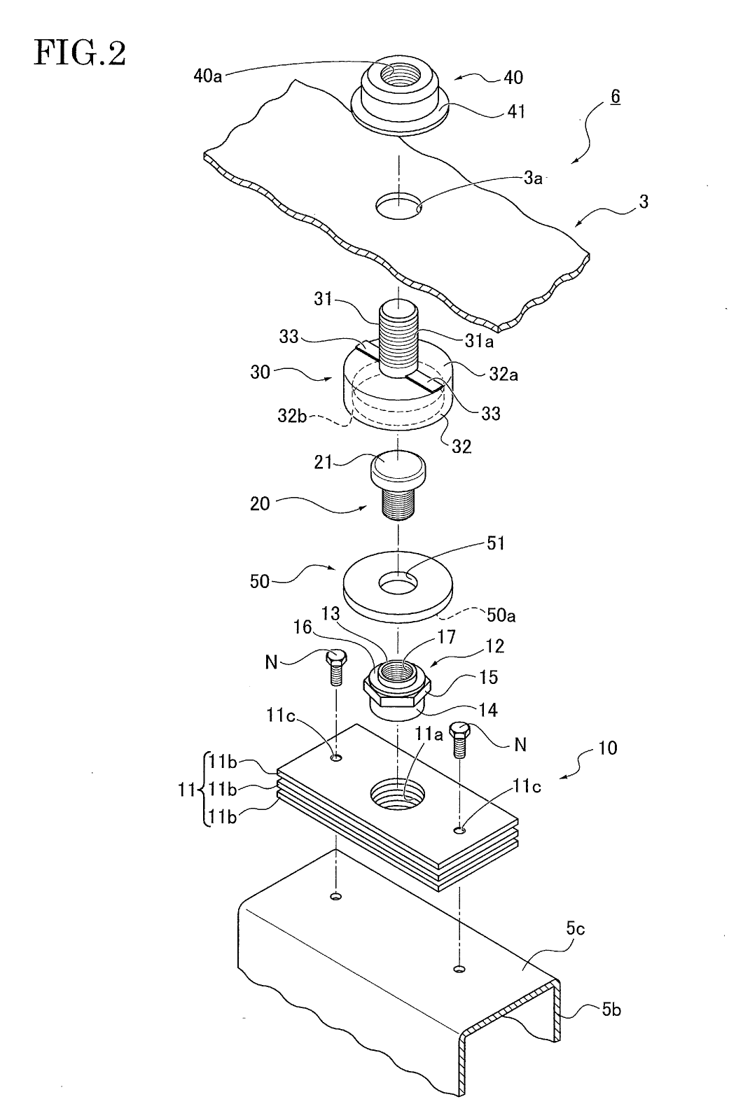

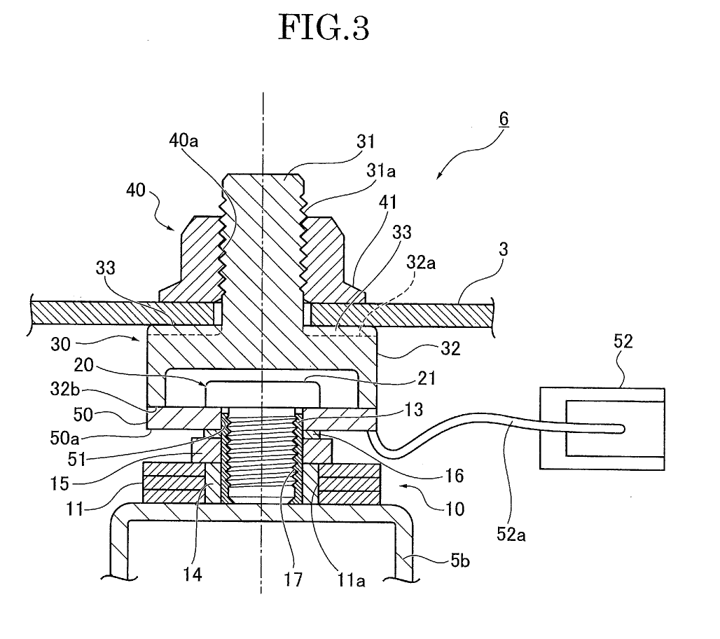

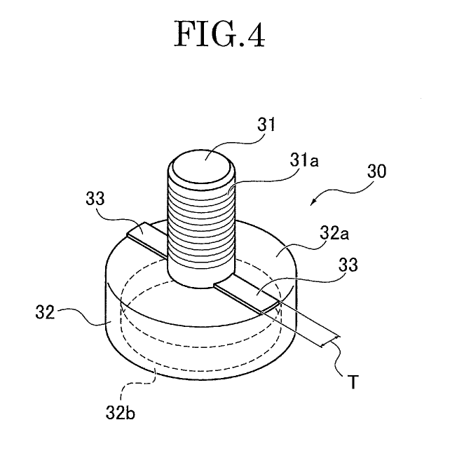

At first, the configuration will be described. FIG. 1 is a perspective view illustrating a vehicle seat to which vehicle seat load sensors according to the embodiment of the present invention are applied. FIG. 2 is an exploded perspective view illustrating the vehicle seat load sensor according to the embodiment of the present invention. FIG. 3 is a longitudinal sectional view illustrating the vehicle seat load sensor according to the embodiment of the present invention. FIG. 4 is a perspective view illustrating a shaft portion in the vehicle seat load sensor according to the embodiment of the present invention.

A vehicle seat 1 illustrated in FIG. 1 includes a seat cushion 2 on which a passenger sits and a seat frame 3 which supports the seat cushion 2. A vehicle interior floor panel 4 includes a pair of seat rails 5 which extends in the vehicle moving direction and is disposed substantially parallel to each other. Each of the seat rails 5 includes a lower seat rail 5a fastened to the vehicle interior floor panel 4 and an upper seat rail 5b which fits the lower seat rail 5a and is slidable in the lower seat rail 5a extending direction.

The four corners (front inner, front outer, rear inner and rear outer) of the seat frame 3 of the vehicle seat 1 are fastened to the upper seat rail 5b, respectively, so that the vehicle seat 1 is slidable together with a pair of the upper seat rails 5b. A vehicle seat load sensor (hereinafter, referred to as a load sensor) 6 is provided between the seat frame 3 and the upper seat rail 5b.

As illustrated in FIGS. 2, 3, the load sensor 6 includes a lower support 10, a fastener 20, a shaft portion 30, an upper support 40 and a flexible body 50.

The lower support 10 includes a flange plate 11 which is fastened to an upper surface 5c of the upper seat rail 5b and a base 12 which is mounted on a fastening hole 11a formed on the flange plate 11.

The flange plate 11 includes a plurality of stacked band-like steel plates 11b each of which extends along the upper seat rail 5b and has a predetermined thickness. This flange plate 11 includes in both end portions thereof screw holes 11c, respectively. The flange plate 11 is fastened to the upper surface 5c of the upper seat rail 5b by fastening screws N which penetrate through the screw holes 11c, respectively.

The base 12 includes a hollow shaft 13 having opening at both ends, an insertion portion 14 which is attached to the outer circumference of one end portion of the shaft 13, a nut 15 which is threadably mounted on the outer circumferential surface of the shaft 13 so as to retain the insertion portion 14 and a support washer 16 through which the shaft 13 penetrates and which is mounted on the nut 15. The shaft 13 includes in the inner circumferential surface thereof a thread groove 17. The other end portion of the shaft 13 projects from the support washer 16. The shaft 13 is inserted into the fastening hole 11a, and then, the insertion portion 14 fits into the fastening hole 11a, so that the base 12 is fastened to the flange plate 11 by fastening with the nut 15.

The fastener 20 is a bolt which is threadably screwed in the thread groove 17 of the shaft 13 of the lower support 10. One end portion of the fastener 20 includes a head portion 21 having an outer diameter which is substantially the same as the outer diameter of the support washer 16.

The shaft portion 30 includes a screw portion 31 and a cylindrical portion 32 fastened to one end of the screw portion 31. The screw portion 31 includes on the outer circumferential surface thereof a thread groove 31a, and penetrates through a fastening hole 3a formed on the seat frame 3. The screw portion 31 is provided in the gravity center, i.e., the center of the after-described seat support. The cylindrical portion 32 is located under the seat frame 3, and sandwiches the seat frame 3 with the upper support 40 which is threadably mounted on the thread groove 31a of the screw portion 31 as described below.

Accordingly, the shaft portion 30 and the upper support 40 become a seat support which supports the seat frame 3, and the cylindrical portion 32 of the shaft portion 30 becomes a load transmitter which transmits a load from the seat frame 3.

This cylindrical portion 32 includes at one end a closed end and the other end an opening end. The screw portion 31 is fastened to the center of the closed end surface. The closed end surface becomes a seat support surface 32a which supports the seat frame 3, and the opening end surface becomes a cylindrical load transmission surface 32b which has contact with the flexible body 50. The seat support surface 32a includes contact projections 33 each of which extends parallel to the upper seat rail extending direction 5b, i.e., the sliding direction of the vehicle seat 1 across the screw portion 31.

The contact projection 33 projects from the seat support surface 32a, and the upper surface of the contact projection 33 has a flat band-like shape. The contact projections 33 correspond to the diameter of the seat support surface 32a, and the width T in the lateral direction is smaller than the diameter of the screw portion 31 (refer to FIG. 4).

The load transmission surface 32b has a size according to the outer edge portion of the flexible body 50, and has contact with the outer edge portion of the flexible body 50 supported between the lower support 10 and the fastener 20 as described below. In this case, the head portion 21 of the fastener 20 is located inside the cylindrical portion 32 (refer to FIG. 3).

The upper support 40 is a nut having a thread groove 40a which is threadably mounted on the thread groove 31a of the outer circumferential surface of the screw portion 31 which has penetrated through the fastening hole 3a of the seat frame 3. One end portion of the upper support 40 includes a holding portion 41 having an outer diameter which is substantially the same as the outer diameter of the cylindrical portion 32. This holding portion 41 has a flange shape, and the holding portion 41 sandwiches the seat frame 3 with the seat support surface 32a when the upper support 40 is threadably mounted on the screw portion 31.

The flexible body 50 is a discoid metal plate which receives a load transmitted from the cylindrical portion 32, and includes in the center thereof a through-hole 51. The flexible body 50 includes a lower surface 50a which faces the upper seat rail 5b, and a not illustrated plurality of strain gauges is provided in the lower surface 50a. In this case, the inner diameter of the through-hole 51 has a size into which the shaft 13 of the lower support 10 can be inserted. By inserting this shaft 13 into the through-hole 51, the circumferential edge portion of the through-hole 51 has contact with the support washer 16 to be supported. If the fastener 20 is threadably mounted on the thread groove 17 of the shaft 13, the head portion 21 of the fastener 20 has contact with the flexible body 50. Thereby, the head portion 21 of the fastener 20 and the support washer 16 of the lower support 10 become a flexible body holder which holds the flexible body 50.

A harness 52 having in the leading end portion a connector 52a is connected to the not illustrated strain gauges. The strain of the flexible body 50 detected by the strain gauges is output via the harness 52. In addition, the connector 52a is connected to a not illustrated controller or the like.

Next, the function will be described.

At first, the existing vehicle seat load sensor and the problem of the existing vehicle seat load sensor will be described, and then, the detection error prevention function in the vehicle seat load sensor of the embodiment will be described.

[Existing Vehicle Seat Load Sensor and Problem of Existing Vehicle Seat Load Sensor]

Currently, a passenger protector such as an air bag or the like is provided in a vehicle for the safety of a passenger. This passenger protector is controlled to operate when a passenger sits on the vehicle seat 1. The vehicle seat 1 includes a plurality of load sensors, i.e., load sensors located in the front inner portion, the front outer portion, the lower inner portion and the lower outer portion of the vehicle seat 1, respectively.

In this case, each of the load sensors is mounted on the upper seat rail 5b of the seat rail 5 fastened to the vehicle. The seat frame 3 of the vehicle seat 1 is placed on the load sensors, and the seat frame 3 is fastened by the upper support. On the other hand, the vehicle seat 1 includes a slide mechanism (not illustrated) which adjusts the lengthwise position, and the upper seat rail 5b is electrically or manually slid by the slide mechanism relative to the lower seat rail 5a, so that the lengthwise position of the vehicle seat 1 can be adjusted.

In this case, if the vehicle seat 1 is moved to the backmost portion, the middle portion and the foremost portion of the seat rail 5, the outputs of the load sensors become a constant regardless of the position of the vehicle seat 1. However, the outputs of the load sensors may be varied according to the position of the vehicle seat 1 by the variability of the attachment accuracy of the seat rail 5, the measurement accuracy of the component, the measurement accuracy of the seat frame 3, the parallelism of the seat rail 5 or the like. For this reason, the operation error of the passenger protector may be generated.

In particular, the influence of the variability of the parallelism of the seat rail 5 is significant, and the detection error is increased if a pair of the seat rails 5 which should be originally arranged in parallel is not arranged in parallel.

Namely, if the distance between a pair of the seat rails 5 is long on the back side, the load sensors are pulled inwardly (toward the central portion of the seat) according to the backward movement of the vehicle seat 1, and relatively incline inwardly to the vehicle seat 1. If the distance between a pair of the seat rails 5 is long on the front side, the load sensors are pulled outwardly (toward the lateral direction of the seat) according to the forward movement of the vehicle seat 1, and relatively incline outwardly to the vehicle seat 1. In each case, the load sensors likely incline in the direction orthogonal to the extending direction of the seat rail 5, which is the sliding direction of the vehicle seat 1, i.e., the lateral direction of the vehicle.

In the existing load sensors, it is considered to provide a cushioning member such as a fiber washer, an aluminum washer, a rubber washer or the like between the seat frame 3 and the seat support surfaces of the load sensors which support the seat frame 3. However, there was a problem in that the deterioration in the cushioning member over a long time, the forgetting of the attaching the cushioning material or the like were considered. There was also a problem of the increase in the manufacturing costs by the addition of the cushioning member.

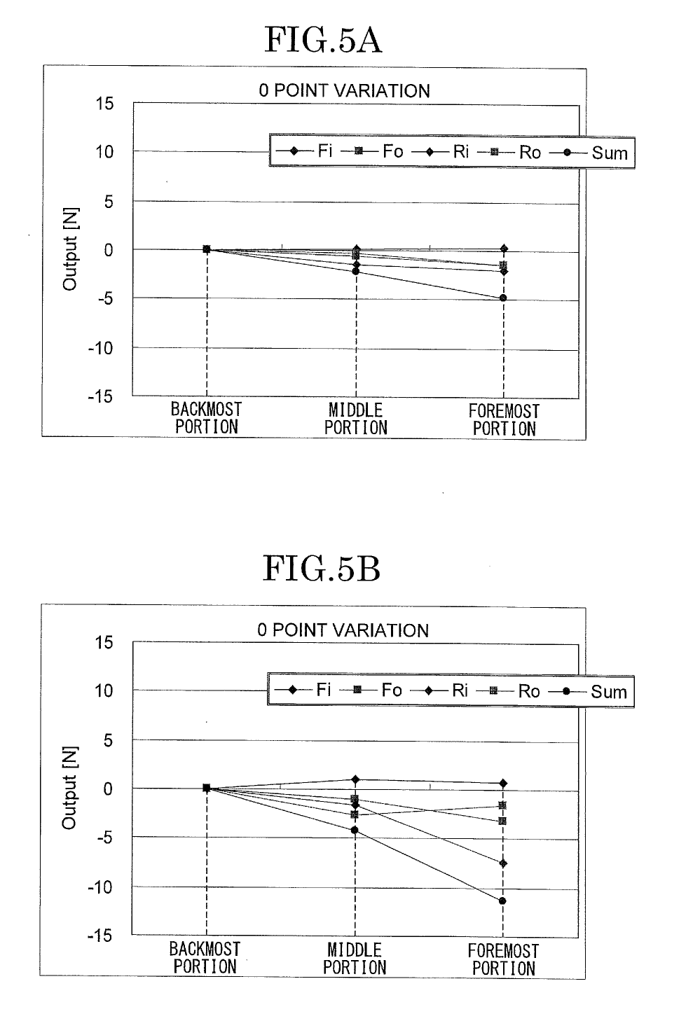

Moreover, as illustrated in FIGS. 5A, 5B, the output values of the load sensors vary even if the cushioning member (in this case, a fiber washer) is sandwiched between the seat frame 3 and the seat support surface. In addition, FIG. 5A is a graph illustrating the variation of the output values of the load sensors when the cushioning member is provided if the distance between the seat rails is long on the back side. FIG. 5B is a graph illustrating the variation of the output values of the load sensors when the cushioning member is provided if the distance between the seat rails is long on the front side. In this case, these graphs illustrate the variation of the output value of each of the load sensors if the vehicle seat 1 is placed in the middle portion of the seat rail 5 and the variation of the output value of each of the load sensors if the vehicle seat 1 is placed in the foremost portion in a case in which the output value of each of the load sensors is set to zero if the vehicle seat 1 is placed in the backmost portion of the seat rail 5. Regarding the graphs, Fi illustrates the output values of the load sensor disposed in the front inner portion, Fo illustrates the output values of the load sensor disposed in the front outer portion, Ri illustrates the output values of the load sensor disposed in the rear inner portion, Ro illustrates the output values of the load sensor disposed in the rear outer portion and Sum illustrates the average output values of all of the load sensors.

[Detection Error Prevention Function]

In order to mount the load sensors 6 of the present embodiment between the seat rail 5 and the vehicle seat 1, at first, the flange plate 11 of the lower support 10 is fastened on the upper surface 5c of the upper seat rail 5b. Then, the insertion portion 14 provided in the shaft 13 is inserted into the fastening hole 11a of the flange plate 11, and the insertion portion 14 is fastened by the nut 15. The support washer 16 is attached to the shaft 13 projecting from the nut 15.

Next, the flexible body 50 is placed on the lower support portion 10. In this case, the shaft 13 is inserted into the through-hole 51 of the flexible body 50, and the circumferential edge portion of the through-hole 51 of the flexible body 50 has contact with the support washer 16 to be supported.

Then, the fastener 20 is inserted into the shaft 13 of the lower support 10 to be threadably mounted. In this case, since the outer diameter of the head portion 21 of the fastener 20 has an outer diameter which is substantially the same as the outer diameter of the support washer 16, the flexible body 50 is sandwiched between the head portion 21 of the fastener 20 and the support washer 16 to be fastened.

Next, the shaft portion 30 is placed on the flexible body 50. In this case, the opening end surface of the cylindrical portion 32 faces the flexible body 50, and the head portion 21 of the fastener 20 is inserted inside the cylindrical portion 32, and the load transmission surface 32b of the cylindrical portion 32 has contact with the outer edge portion of the flexible body 50.

Then, the screw portion 31 of the shaft portion 30 is inserted into the fastening hole 3a of the seat frame 3, the seat frame 3 is supported by the support surface 32a of the cylindrical portion 32, and the upper support 40 is threadably mounted on the screw portion 31. Thereby, the seat frame 3 is sandwiched between the shaft portion 30 and the upper support 40 to be fastened, and the load sensor 6 is mounted between the seat rail 5 and the vehicle seat 1. In this case, the seat frame 3 is located over the seat support surface 32a of the shaft portion 30, and this seat support surface 32a has the contact projection 33. The seat frame 3 thereby has contact with the contact projection 33 to be supported.

If a passenger sits on the seat cushion 2, the load acting on the vehicle seat 1 is transmitted to the seat frame 3 from the seat cushion 2, and is transmitted to the flexible body 50 via the shaft portion 30. In this case, the shaft portion 30 supports the seat frame 3 by the shaft support surface 32a, and transmits the load acting on the vehicle seat 1 via the load transmission surface 32b. The transmitted load acts on the outer edge portion of the flexible body 50. On the other hand, since the circumferential edge portion of the through hole 51 of the flexible body 50 has contact with the support washer 61 to be supported, the reaction force to the load which is transmitted from the vehicle seat 1 acts on the central portion of the flexible body 50. Thereby, strain is generated in the flexible body 50, and the load which is transmitted from the vehicle seat 1 is detected by detecting the strain.

In this case, in the load sensor 6 in this embodiment, the seat support surface 32a of the shaft portion 30 includes the contact projection 33 extending parallel to the sliding direction of the vehicle seat 1, and the load transmitted from the vehicle seat 1 is input to the flexible body 50 via the contact projection 33. Accordingly, the load from the vehicle seat 1 is received only by the contact projection 33, so that the area which receives the load can be reduced. The seat frame 3 can be supported without backlash even if a measurement error of the components or the like is caused.

Since the contact projection 33 extends parallel to the sliding direction of the vehicle seat 1, even if the parallelism of a pair of seat rails 5 is low, and the vehicle seat 1 inclines in the direction orthogonal to the sliding direction, namely, the vehicle lateral direction when the vehicle seat 1 slides and the load sensor 6 inclines in the direction orthogonal to the sliding direction to the vehicle seat 1, the portion of the seat support surface 32a which is a portion except the contact projection 33 hardly has contact with the seat frame 3. For this reason, the load which is transmitted to the load transmission surface 32b having contact with the flexible body 50 is hardly biased, so that the unnecessary strain of the flexible body 50 can be prevented.

As a result, even if the relative inclination is generated to the vehicle seat 1, the unnecessary strain of the flexible body 50 is prevented, so that the detection error can be thereby prevented.

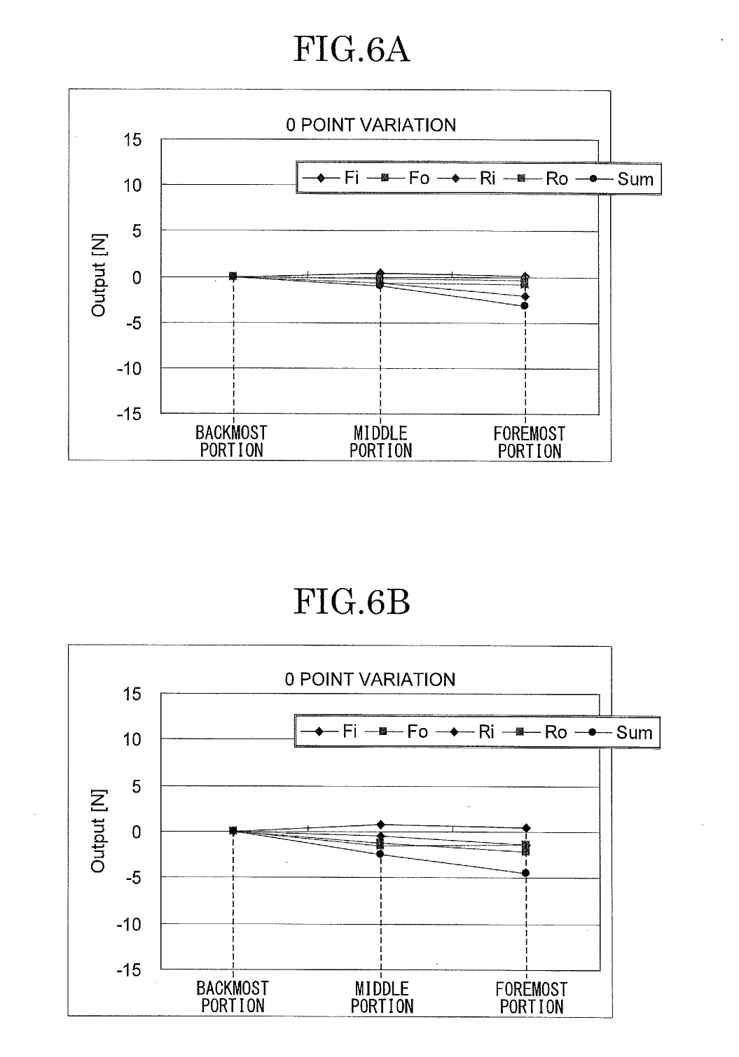

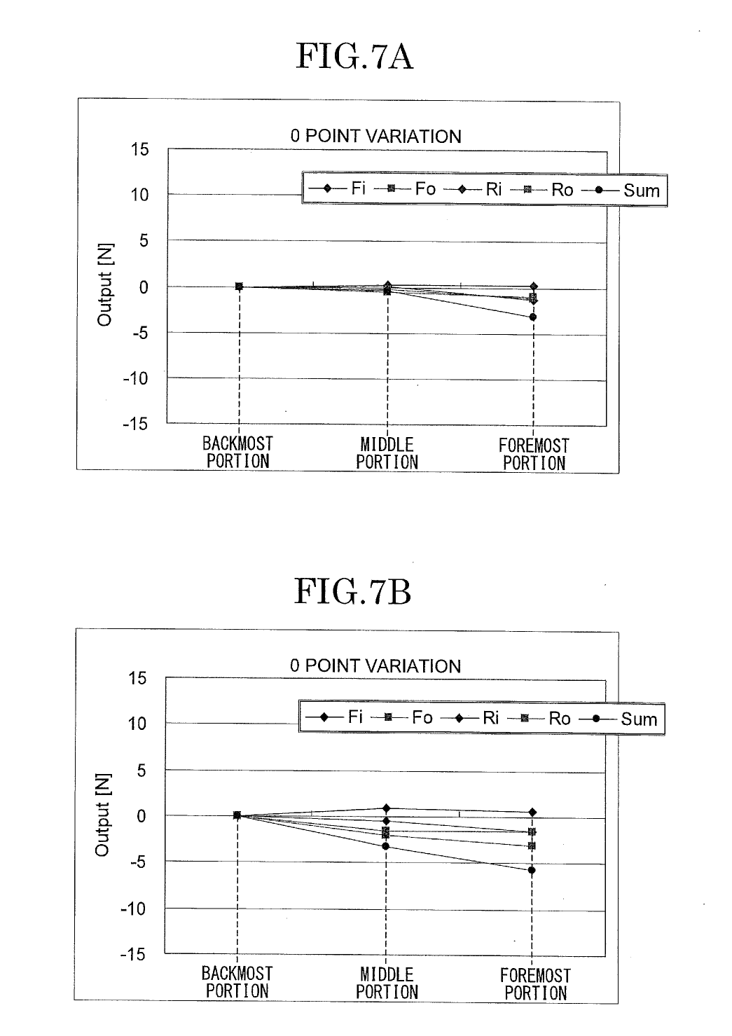

FIG. 6A is a graph illustrating the variation of the output values of the load sensors when the contact projection having a width of 5 mm in the lateral direction is provided in the seat support surface if the distance between the seat rails is long on the back side. FIG. 6B is a graph illustrating the variation of the output values of the load sensors when the contact projection having a width of 5 mm in the lateral direction is provided in the seat support surface if the distance between the seat rails is long on the front side. FIG. 7A is a graph illustrating the variation of the output values of the load sensors when the contact projection having a width of 10 mm in the lateral direction is provided in the seat support surface if the distance between the seat rails is long on the back side. FIG. 7B is a graph illustrating the variation of the output values of the load sensors if the contact projection having a width of 10 mm in the lateral direction is provided in the seat support surface if the distance between the seat rails is long on the front side.

Each of FIGS. 6A, 6B, 7A, 7B illustrates the variation of the output value of each of the load sensors 6 if the vehicle seat 1 is placed in the middle portion of the seat rail 5 and the variation of the output values of each of the load sensors 6 if the vehicle seat 1 is placed in the foremost portion of the seat rail 5 in a case in which the output value of each of the load sensors 6 is set to zero if the vehicle seat 1 is placed in the backmost portion of the seat rail 5. In addition, in the graphs, Fi denotes the output values of the load sensor disposed in the front inner portion, Fo denotes the output values of the load sensor disposed in the front outer portion, Ri denotes the output values of the load sensor disposed in the rear inner portion, Ro denotes the output values of the load sensor disposed in the rear outer portion and Sum denotes the average of the output values of all of the load sensors.

According to FIGS. 6A, 6B, 7A, 7B, the variation of the output values by the difference in the positions of the vehicle seat 1 is smaller than the variation (refer to FIGS. 5A, 5B) of the output values in the existing load sensors even if the distance between the guide rails is long on the back side (refer to FIGS. 6A, 7A) and the distance between the guide rails is long on the front side (refer to FIGS. 6B, 7B). In particular, the variation of the output values is small in the contact projection 33 having a width of 10 mm in the lateral direction (refer to FIGS. 7A, 7B) compared with the contact projection 33 having a width of 5 mm in the lateral direction (refer to FIGS. 6A, 6B), so that the effect which controls the detection errors is improved.

Next, the effects will be described.

According to the vehicle seat load sensor in the present embodiment, the following effects can be obtained.

The vehicle seat load sensor 6 which is attached under the slidable vehicle seat 1 and is configured to detect the load acting on the vehicle seat 1 includes the seat support (shaft portion 30, upper support 40) configured to support the vehicle seat 1, the load transmitter (cylindrical portion 32) configured to transmit the load from the seat support 30, 40, the flexible body 50 configured to receive the load transmitted from the load transmitter 32, and the flexible body holder (lower support 10, fastener 20) configured to hold the flexible body 50, wherein the seat support 30, 40 includes the seat support surface 32a configured to support the vehicle seat 1, and the contact projection 33 which extends parallel to the sliding direction of the vehicle seat 1 is provided in the seat support surface 32a. Accordingly, even if the relative inclination occurs in the vehicle seat 1, the generation of the unnecessary strain of the flexible body 50 is prevented, so that the detection error can be prevented.

In the vehicle seat load sensor of the present embodiment, since the contact projection which extends parallel to the sliding direction of the vehicle seat is provided in the seat support surface configured to support the vehicle seat, the load acting on the vehicle seat is input via the contact projection. More specifically, by receiving the load from the vehicle seat only with the contact projection, the area which receives the load can be reduced, so that the vehicle seat can be supported without backlash. Moreover, since the contact projection extends parallel to the sliding direction of the vehicle seat, even if the inclination occurs in the direction orthogonal to the sliding direction of the vehicle seat, the portion of the seat support surface which is a portion except the contact projection hardly has contact with the vehicle seat. As a result, even if the relative inclination occurs in the vehicle seat, the generation of the unnecessary strain of the flexible body is prevented, so that the detection error can be prevented.

Although the vehicle seat load sensor of the present invention has been described based on the embodiment, the specific configurations are not limited to the above embodiment, and variations in the design, additions and the like may be made as long as it does not depart from the scope of the present invention according to the following claims.

In the above embodiment, the projection 33 extends parallel to the sliding direction of the vehicle seat 1. However, a projection which has contact with the vehicle seat by the two points which sandwich the gravity center of the seat support 30, 40 therebetween can be formed.

By using such a projection, the effects, which are similar to the effects when the projection 33 extending parallel to the sliding direction of the vehicle seat 1 is provided in the seat support surface 32a of the seat support 30, can be obtained.

In this case, the distances from the gravity center of the seat support 30, 40 to the two points are preferably the same as each other.

For example, a plurality of projections can be provided in the circumference of the gravity center of the seat support 30, 40, namely, the circumference of the screw portion 31 at intervals along the circumferential direction of the seat support surface 32a of the seat support 30, 40.

Accordingly, regardless of the inclination direction of the load sensor, the generation of the unnecessary strain of the flexible body 50 by the moment load acting on the load sensor is prevented, so that the detection error can be prevented.

Moreover, the projection 33 can be a circular projection which is formed in the circumference of the gravity center of the seat support 30, 40, namely, the circumference of the screw portion 31, and extends along the circumferential direction of the seat support surface 32a of the seat support 30, 40.

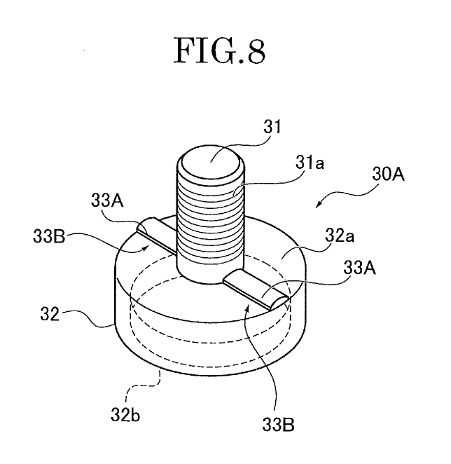

In the above embodiment, the contact projection 33 provided in the seat support surface 32a has the flat band-like top surface. However, like a contact projection 33B provided in a shaft portion 30A illustrated in FIG. 8, the top surface (seat contact surface) 33A which has contact with the vehicle seat 1 can be curved in a convex form.

FIG. 8 illustrates an example in which an upper surface 33A of the projection 33B, which has contact with the vehicle seat 1, is curved in the convex form. However, the projection 33B having a convex sectional shape which projects toward the vehicle seat 1 and has an apex can be formed.

In this case, the area which receives the load from the vehicle seat 1 can be further reduced, and even if the relative inclination is generated to the vehicle seat 1, the generation of the detection error can be further prevented by absorbing this inclination.

The present application is based on the claims priority from Japanese Patent Application No. 2008-315782, field on Dec. 11, 2008, the disclosure of which is hereby incorporated by reference in its entirety.

What is claimed is:

1. A vehicle seat load sensor which is attached under a vehicle seat, and is configured to detect a load acting on the vehicle seat, comprising:
a seat support configured to support a vehicle seat; and
a flexible body configured to receive the load from the seat support,
the seat support including a seat support surface configured to support the vehicle seat and a projection which is formed on the seat support surface and is configured to have contact with the vehicle seat.

2. The vehicle seat load sensor according to claim 1, wherein the projection has contact with the vehicle seat by at least two points which sandwich a gravity center of the seat support therebetween.

3. The vehicle seat load sensor according to claim 2, wherein the distances from the gravity center of the seat support to the two points are equal to each other.

4. The vehicle seat load sensor according to claim 1, wherein the seat support is movable together with the vehicle seat, and the projection extends along the moving direction of the vehicle seat.

5. The vehicle seat load sensor according to claim 4, wherein the projection extends to pass through the gravity center of the seat support.

6. The vehicle seat load sensor according to claim 1, wherein a cross-section shape of the projection includes a convex shape which projects toward the vehicle seat and has an apex.

7. The vehicle seat load sensor according to claim 1, wherein the projection has a seat contact surface which has contact with the vehicle seat, and the seat contact surface is curved into a convex shape.

8. The vehicle seat load sensor according to claim 4, wherein the seat support has a screw portion which is fastened to the vehicle seat, and a measurement of the projection in the width direction orthogonal to an extending direction of the screw portion is smaller than a diameter of the screw portion.
